(19) United States
(12) Patent Application Publication
(10) Pub. No.: US 2012/0084142 A1
(43) Pub. Date: Apr. 5, 2012

(54) BID LANDSCAPE FORECASTING IN ONLINE ADVERTISING

(75) Inventors: Wei Li, San Jose, CA (US); Ying Grace Cui, Sunnyvale, CA (US); Ruofei Zhang, Mountain View, CA (US); Jianchang Mao, San Jose, CA (US)

(73) Assignee: Yahoo! Inc., Sunnyvale, CA (US)

(21) Appl. No.: 12/895,773

(22) Filed: Sep. 30, 2010

(51) Int. Cl. G06Q 30/00

(52) U.S. Cl. 705/14.46

(57) ABSTRACT

Techniques are provided for advertiser bid forecasting in online advertising, including display advertising. Methods are provided in which key targeting-related user segments are determined from bidding statistics. A feature set is extracted from an impression opportunity, based at least in part on the bidding statistics. A gradient boosting descent tree technique is utilized in determining an initial bid forecasting result. A linear regression-based model is used in post-tuning to arrive at a post-tuned result. For short-term forecasting, this may be the final result. For long-term forecasting, a hybrid approach may be utilized with further processing including utilization of a publisher-specific model.

### BACKGROUND

Advertiser bid forecasting, including bid landscape forecasting, is of great importance to advertisers (including their agents, proxies, etc.) in managing and optimizing their online advertising campaigns, including understanding and optimizing bidding in view of bid forecasting information. However, bid forecasting can be very challenging.

There is a need for improved techniques for bid forecasting, including bid landscape forecasting.

### SUMMARY

Some embodiments of the invention provide techniques for use in advertiser bid forecasting, including bid landscape forecasting, in online advertising, including display advertising. Methods are provided in which key targeting-related user segments are determined from historical advertising bidding statistics. A feature set, which may be an optimized feature set, is extracted (where extracted can broadly include determined, etc.) from an impression opportunity, based at least in part on the bidding statistics (which can broadly include being based on any portion of the bidding statistics). A gradient boosting descent tree technique is utilized in determining an initial bid forecasting result. A linear regression-based model is or may be used in post-tuning to arrive at a post-tuned result, including use of the feature set. For short-term forecasting, this may be the final result.

For long-term forecasting, a hybrid approach may be utilized with further processing including utilization of a linear programming-based publisher-specific model, including use of a post-tuned bid forecasting result (if post-tuning was needed), and which may include techniques for adjusting in view of holiday effects.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

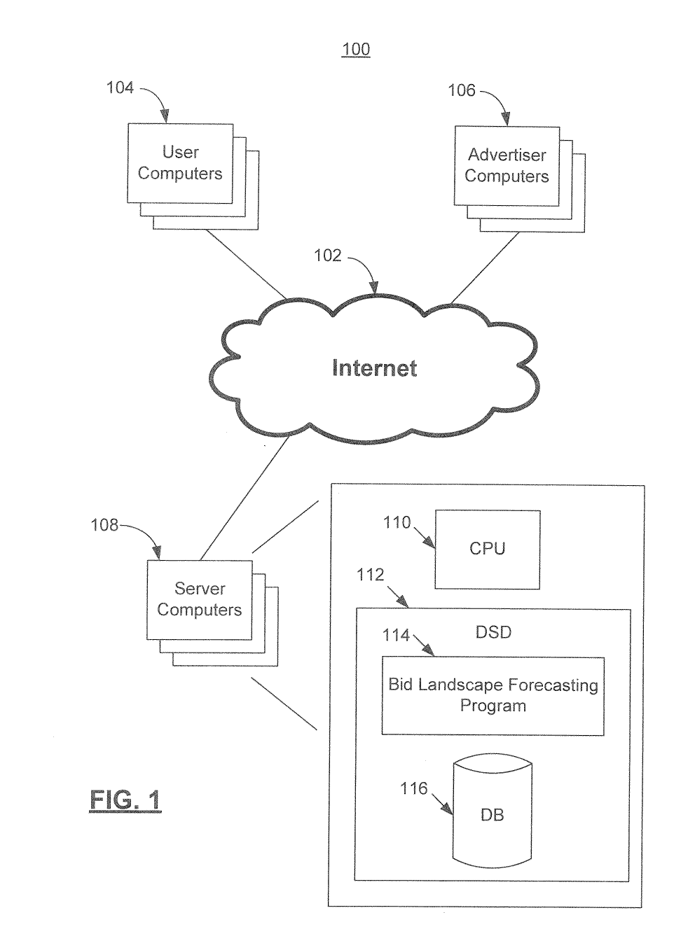

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as ell as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Bid Landscape Forecasting Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

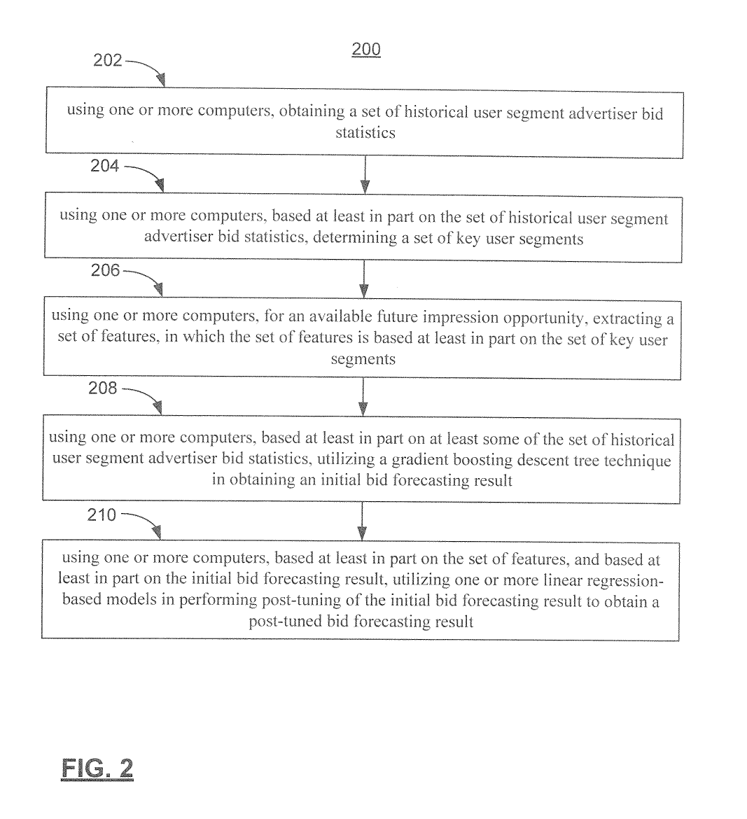

FIG. 2 is a flow diagram illustrating a method 200 according to one embodiment of the invention. At step 202, using one or more computers, a set of historical user segment advertiser bid statistics is obtained.

At step 204, using one or more computers, based at least in part on the set of historical user segment advertiser bid statistics, a set of key user segments is determined.

At step 206, using one or more computers, for an available future impression opportunity, a set of features is extracted, in which the set of features is based at least in part on the set of key user segments.

At step 208, using one or more computers, based at least in part on at least some of the set of historical user segment advertiser bid statistics, a gradient boosting descent tree technique is used in obtaining an initial bid forecasting result.

At step 210, using one or more computers, based a cast in part on the set of features, and based at least in part on the initial bid forecasting result, one or more linear regression-based models are utilized in performing post-tuning of the initial bid forecasting result to obtain a post-tuned bid forecasting result, which may be a final result in short-term forecasting.

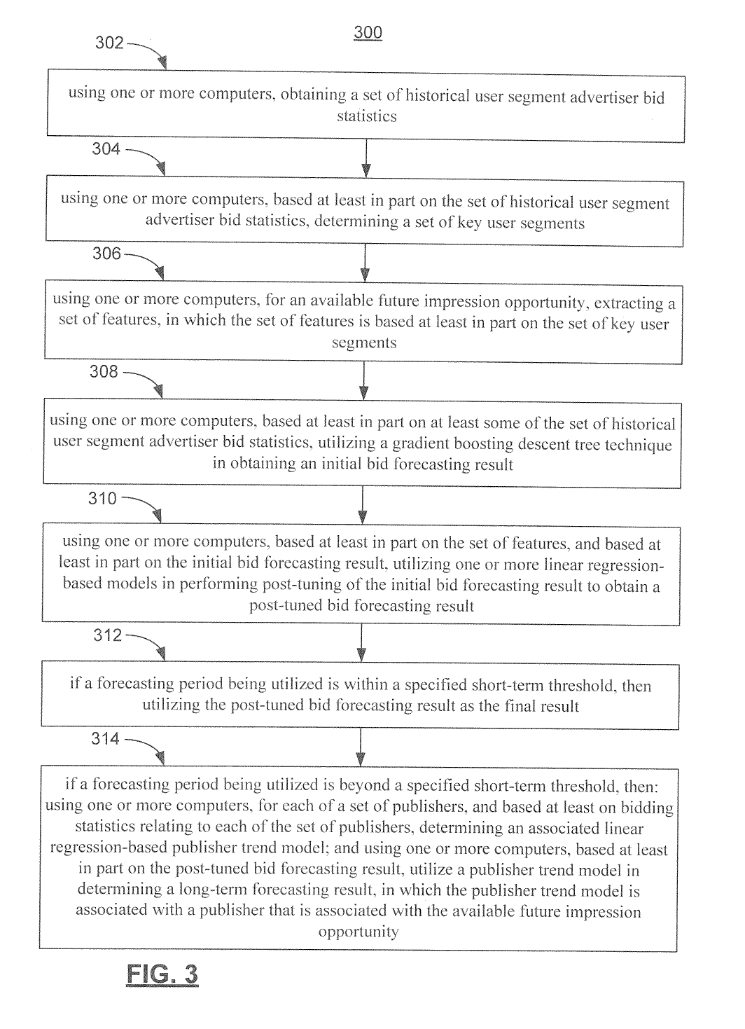

FIG. 3 is a flow diagram illustrating a method 300 according to one embodiment of the invention. Steps 302-310 are similar to steps 202-210 as depicted in FIG. 2.

At step 312, if a forecasting period being utilized is within a specified short-term threshold, then the post-tuned bid forecasting result is used as the final result.

At step 314, if a forecasting period being utilized is beyond a specified short-term threshold, then using one or more computers, for each of a set of publishers, and based at least on bidding statistics relating to each of the set of publishers, an associated linear regression-based publisher trend model is determined. Furthermore, using one or more computers, based at least in part on the post-tuned bid forecasting result, a publisher trend model is utilized in determining a long-term forecasting result, in which the publisher trend model is associated with a publisher that is associated with the available future impression opportunity.

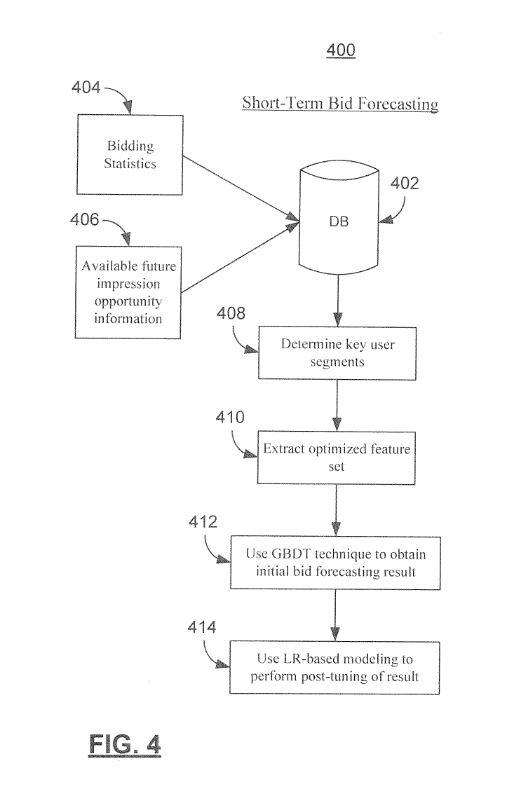

FIG. 4 is a block diagram 400 illustrating one embodiment of the invention, in a simplified fashion, which may be a short-term bid landscape forecasting technique. Various information may be obtained and stored in one or more databases 402, which includes bidding statistics 404 and available future impression opportunity information 406.

Block 408 includes determining key user segments.

Block 410 includes extracting an optimized feature set.

Block 412 includes use of a gradient boosting descent tree technique to obtain initial bid forecasting result.

Block 414 includes using linear regression-based modeling to perform post-tuning of result.

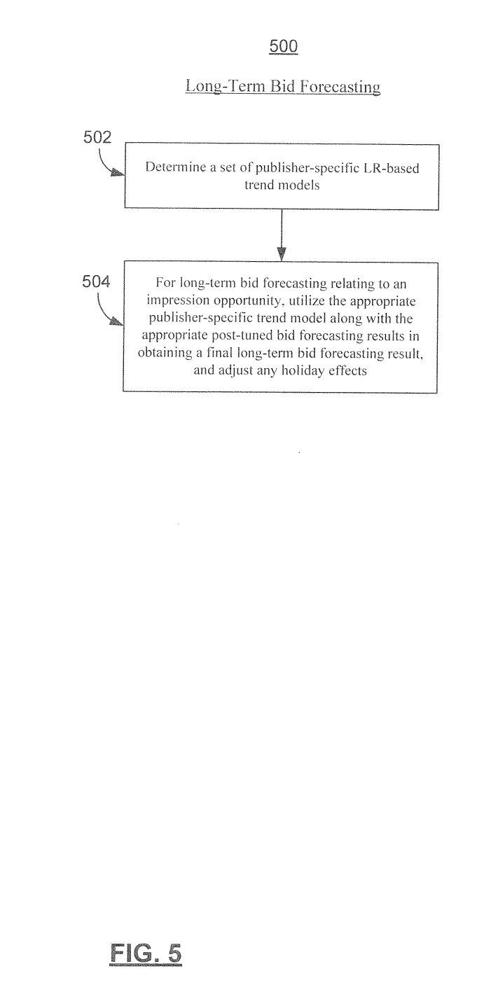

FIG. 5 is a flow diagram illustrating a method 500 according to one embodiment of the invention, which may be a long-term bid landscape forecasting method. Step 502 includes determining a set of publisher-specific linear regression-based trend models.

Step 504 includes, for long-term bid forecasting relating to an impression opportunity, utilizing the appropriate publisher-specific trend model along with the appropriate post-tuned bid forecasting results in obtaining a final long-term bid forecasting result, and adjusting for any holiday effects. In some embodiments, a post-tuned result is only utilized assuming post-tuning was necessary or utilized.

In some embodiments, bid forecasting, including bid landscape forecasting, in performance based display advertising is used, for example, in predicting or forecasting the hid price distribution that a given advertisement opportunity would fetch on a display advertising exchange marketplace. In some embodiments, the system is designed to be able to meet business needs in part by creating advertiser custom targeting profiles, i.e., selecting targeted segments of users and publishers. Such advertisement targeting can influence a bid value. A bid landscape forecasting system can be crucial for advertisers to manage and optimize advertising campaigns, which can include, for example, adjusting bid and goal amounts to be competitive on the marketplace and to meet advertiser return-on-investment (ROI) goals.

Some embodiments of the invention provide a model, which can be a hybrid model, for bid landscape forecasting. In some embodiments, for short-term forecasting, which can be defined as, for example, less than one month, a regression-based model s developed with segments-oriented post-tuning. In some embodiments, for long-term forecasting, which can be defined as, for example, longer than one month and up to one year, along term adjustment model is provided that allows different aggregation levels and significantly improves long-term bid landscape forecasting accuracy.

In an online display advertising exchange, advertisers may buy audience/impression traffic from publishers and networks through an auction mechanism. Advertisers may create line items (contracts) for their marketing needs and specify the targeted users and publishers to be associated with each line item so the advertisements can be delivered to the users they are interested in on the pages they target. Advertisers may desire or need to have a system to forecast, for example, the minimal bid amount they need to pay in order to win the advertising inventory, for example, they target so they can manage their advertising campaign and budget allocation effectively.

There can a number of challenges to provide an accurate forecasting system. First, there may be a myriad of targeting attributes and complex Boolean rules to match what an advertiser wants to target. Amongst these targeting attributes, user segments can be especially challenging to deal with. Also, it can be needed to provide forecasting for both short-term and long-term periods. Because of the often very dynamic nature of an exchange, i.e., the supply and demand change significantly during the time, it can be very challenging to give good forecasting for a long term window.

A problem for a bid landscape forecasting system can be to predict or forecast the winning bid that will win a sample on the exchange marketplace, given a list of attributes (some attributes may themselves be a list of sub-attributes) associated with this sample. One attribute which can be important is user segment(s), which can describe the characteristics, online behaviors, or historical activities of a user, which may be identified including use of cookies. One user can have or be associated with multiple segments. These user segments can be publisher defined segments, such as behavior targeting segments and publisher section segments, or advertiser defined segments, such as search or site re-targeting segments. Often, for each line item on the display advertising exchange, an account manager or agency may come up with a list of targeting user segments. These segments may help them identify users that may be responsive to their advertisement, and to whom they want to show the advertisements.

The presence of targeted user segments can substantially influence the bid value. For instance, Toyota may be willing to pay $2 CPM to users with the behavioral targeting segments auto/salan/Camry. However, in online bid landscape forecasting, an objective can be to predict the bid value associated with a certain impression. There is generally no advertiser side targeting information available. Therefore, it may be needed to learn the segments' impact on bidding through, for example, offline data mining. Challenges can be presented by issues relating to (a) availability, since, on the offline impression log, only a user segment list is available, and advertiser targeting is generally unknown, and (b) diversity, since segments change quickly and advertisers can define their own segments and change the targeting at any time. Some embodiments of the invention utilized a regression model-based dynamic approach, which takes advantage of user segments information to improve forecasting accuracy.

Long-term forecasting can be very important. In some embodiments of the invention, a regression-based bid model is provided that is trained with log data from two consecutive months, where the first month serves as historical features and the second month is the regression target. In other words, the model captures immediate trends between months. Given a targeting date, this model may require access to the previous month's history to make an accurate prediction. For example, assume that the current date is Sep. 1, 2010 and log data is available until Aug. 31, 2010. It may be practical for the regression model to predict the bid for any day in September since the required history data is available. However, if the targeting date is in November, history data for October is not available yet. It can be important to have a long term bid trend model that captures the changes from September to November and adjusts the prediction from the model appropriately.

Some embodiments of the invention use user segments feature to improve short-term bid forecasting accuracy. For long-term forecasting, some embodiments add to techniques with long-term bid trend modeling.

Some embodiments include use of user segments features in monthly bid forecasting. Some specific details and examples are provided as follows, although the invention contemplates many different variations.

In some embodiments, due to the complexity of user segments features, they generally cannot be effectively used as other typical user features like gender, age, geo, and so on. Because of the different characteristics of such features, including user and publisher features, some embodiments include development of a regression-based model that is composed of two stages. In the first stage, eight features are used, including hour-of-day, gender, age, geo, publisher, ad size and site. Due to the stability and limited cardinality in these features, it is practical to build a gradient descent boosting tree (GBDT) to perform bid forecasting. In the second stage, based at least in part on the GBDT output, high level segment features are extracting for use in post-tuning the forecasted bid.

In some embodiments, step one is to collect daily user segments bid statistics. For each segment observed in the log data, its total impressions are recorded, as average bid value and bid standard deviation (std). Key segments are defined as those with average hid five times bid std. These key segments can provide the strongest signals in the data due to their low variance, and they can be most likely to be targeted by advertisers.

In some embodiments, Step two is, for an incoming impression opportunity, to scan its user segment list, read the previous day's segments bid table, and extract four high level features. They are:

1. Average bid value for all segments in the user segment list. For all the segments in the list, the average bid value is taken according to segments bid table;
2. Maximum bid value for all segments in the user segment list. For all the segments in the list, the average bid value is taken according to segments bid table;
3. Average bid value for key segments in the user segments list. For all the segments in the list, the average bid is taken of only those key segments as defined above; and
4. Bid value of the principal key segment in the user segment list. The principal keys segment is the key segment which has the highest bid/std ratio. If two principal key segments have the same ratio, the one with higher impression volume is selected as it has a larger coverage.

In some embodiments, step three is to learn linear regression (LR) models to post-tune the bid estimation via the four segments features and estimated bid from GBDT. The training output will be the model coefficients. This can include:

1. Train a LR model with those events/impressions having key segments, i.e., with all four segments features; and
2. Train a LR model with those event/impressions without key segments, i.e., with only two segments features.
In some embodiments, step four is to use the LR model in performing post tuning of the estimated bid value to generate final forecasting. After scanning the incoming event's segment list and extract segment features using GBDT in step two, step four can include:
1. Deciding if post tuning is needed for this impression. Due to the highly positive correlation between forecasting error and bid value, only when the bid value exceeds some threshold post tuning process is triggered; and
2. If the sample has key segments, feed it to the LR model trained with key segments; if no feed to the LR model trained without key segments features.

Embodiments using such an approach as the four-step approach above can capture the segments information to boost short-term bid value prediction accuracy.

Some embodiments of the invention provide a long term bid model that combines trends over time and holiday bid spikes. It might be desirable to have one model for every sample, but it is generally impractical, too expensive or unreliable. With data analysis, it may be recognized that samples sharing the same publisher I.D. tend to have similar trends over time. Therefore, in some embodiments, the long term model is built at the publisher level. It is also possible to aggregate at other levels, such as site.

Some embodiments employing long-term forecasting include, as step one, identifying the top publishers that occur every day in one year's log data. These publishers may account for roughly 95% of the total traffic. For efficiency and reliability, some embodiments include only building models for these publishers and ignoring others, but other embodiments may use different approaches.

In some embodiments, step two includes, for each publisher, calculating its daily average bid for one year.

In some embodiments, step three includes techniques to minimize or remove any holiday effects. Since December generally has much higher bids than other months, some embodiments include replacing it with an interpolation between November and January.

In some embodiments, step four includes learning a trend model for each publisher. The one year data may be evenly split into training and validation sets. The model is based on linear regression. Various embodiments can include variations such as learning a single linear model, learn two linear models where the cut point is decided by minimizing the overall mean square error, or learning three linear models where the cut points are the maximum and minimum during the time range, respectively. Log-linear regression may also be utilized and obtain a total of six models from the training data. In some embodiments, the validation set is utilized to choose the best model. Furthermore in some embodiments, validation data may be used to determine the right model for each publisher.

In some embodiments, step five includes calculating holiday effects. For each holiday, the difference is calculated between its original bid and the trend model output. At test time, the GBDT model first makes a prediction using the latest history. If the targeting date is within one month of the current date, no modification is necessary. Otherwise, the trend model calculates the bid ratio between the targeting date and the current date based on the publisher I.D. The final prediction is then original prediction multiplied by ratio+holiday effect of the targeting date.

While the invention is described with reference to the above drawings, the drawings are intended to be illustrative, and the invention contemplates other embodiments within the spirit of the invention.

1. A method comprising:
using one or more computers, obtaining a set of historical user segment advertiser bid statistics;
using one or more computers, based at least in part on the set of historical user segment advertiser bid statistics, determining a set of key user segments;
using one or more computers, for an available future impression opportunity, extracting a set of features, wherein the set of features is based at least in part on the set of key user segments;
using one or more computers, based at least in part on at least some of the set of historical user segment advertiser bid statistics, utilizing a gradient boosting descent tree technique in obtaining an initial bid forecasting result; and
using one or more computers, based at least in part on the set of features, and based at least in part on the initial bid forecasting result, utilizing one or more linear regression-based models in performing post-tuning of the initial bid forecasting result to obtain a post-tuned bid forecasting result.

3. The method of claim 1, wherein the set of key user segments are user segments associated with at least a specified, above-average threshold.

4. The method of claim 1, wherein the set of key user segments are user segments determined to be optimized with regard to leading to an accurate post-tuned bid forecasting result.

5. The method of claim 1, wherein the method is utilized for short-term bid forecasting.

6. The hod of claim 1, wherein obtaining a post-tuned bid forecasting result comprises obtaining a forecasted minimum necessary bid.

7. The method of claim 1, wherein the method is utilizing for short-term bid forecasting, and wherein short-term bid forecasting includes forecasting for periods of up to one month.

7. The method of claim 1, comprising obtaining a set of user segments associated with the available future impression opportunity.

8. The method of claim 1, comprising obtaining a set of user segments associated with the available future impression opportunity, and wherein the set of user segments comprises, based at least in part on the set of historical user segment advertiser bid statistics:
an average bid value for all user segments in the set of user segments associated with the available future impression opportunity;
a maximum bid value for all user segments in the set of user segments associated with the available future impression opportunity;
an average bid value for key user segments in the set of user segments associated with the available future impression opportunity; and
a bid value associated with a principal key user segment in the set of user segments associated with the available future impression opportunity, wherein the principal key user segment is the key user segment in the set of user segments associated with the available future impression opportunity that has the highest ratio of its associated bid value relative to a standard associated bid value.

9. The method of claim 1, wherein utilization of the set of key user segments and the set of features allows for an optimized compromise between computational efficiency and accuracy.

10. The method of claim 1, comprising:
using one or more computers, for each of a set of publishers, and based at least on bidding statistics relating to each of the set of publishers, determining an associated linear regression-based publisher trend model; and
using one or more computers, based at least in part on the post-tuned bid forecasting result, utilize a publisher trend model in determining a long-term forecasting result, wherein the publisher trend model is associated with a publisher that is associated with the available future impression opportunity.

11. The method of claim 10, wherein the method is utilized for forecasting periods of greater than one month.

12. The method of claim 10, comprising:
using one or more computers, for each of a set of publishers, and based at least on bidding statistics relating to each of the set of publishers, determining an associated linear regression-based publisher trend model; and
based at least in part on the post-tuned bid forecasting result, utilize a publisher trend model in determining a long-term forecasting result, wherein the publisher trend model is associated with a publisher that is associated with the available future impression opportunity;
comprising, if a date associated with the available future impression opportunity is a holiday, adjusting the long-term forecasting result to account for a holiday effect.

13. The method of claim 12, wherein the method is utilized for forecasting periods of greater than one month.

14. A system comprising:
one or more server computers coupled to a network; and
one or more databases coupled to the one or more server computers;
wherein the one or more server computers are for:
obtaining a set of historical user segment advertiser bid statistics;
based at least in part on the set of historical user segment advertiser bid statistics, determining a set of key user segments;
for an available future impression opportunity, extracting a set of features, wherein the set of features is based at least in part on the set of key user segments;
based at least in part on at least some of the set of historical user segment advertiser bid statistics, utilizing a gradient boosting descent tree technique in obtaining an initial bid forecasting result; and
based at least in part on the set of features, and based at least in part on the initial bid forecasting result, utilizing one or more linear regression-based models in performing post-tuning of the initial bid forecasting result to obtain a post-tuned bid forecasting result.

15. The system of claim 14, wherein at least one of the one or more servers is coupled to an online advertising exchange.

16. The system of claim 14, wherein the set of key user segments are user segments associated with unusually high advertiser bid amounts.

17. The system of claim 14, wherein the set of key user segments are user segments associated with at least a specified, above-average threshold.

18. The system of claim 14, wherein the set of key user segments are user segments determined to be optimized with regard to leading to an accurate post-tuned bid forecasting result.

19. The system of claim 14, wherein the system is utilized for short-term bid forecasting, and wherein short-term bid forecasting includes forecasting for periods of up to one month.

20. A computer readable medium or media containing instructions for executing a method comprising:
using one or more computers, obtaining a set of historical user segment advertiser bid statistics;
using one or more computers, based at least in part on the set of historical user segment advertiser bid statistics, determining a set of key user segments;
using one or more computers, for an available future impression opportunity, extracting a set of features, wherein the set of features is based at least in part on the set of key user segments;
using one or more computers, based at least in part on at least some of the set of historical user segment advertiser bid statistics, utilizing a gradient boosting descent tree technique in obtaining an initial bid forecasting result;
using one or more computers, based cast in part on the set of features, and based at least in part on the initial bid forecasting result, utilizing one or more linear regression-based models in performing post-tuning of the initial hid forecasting result to obtain a post-tuned bid forecasting result;
if a forecasting period being utilized is within a specified short-term threshold, then utilizing the post-tuned bid forecasting result as the final result; and
if a forecasting period being utilized is beyond a specified short-term threshold, then:
using one or more computers, for each of a set of publishers, and based at least on bidding statistics relating to each of the set of publishers, determining an associated linear regression-based publisher trend model; and
using one or more computers, based at least in part on the post-tuned bid forecasting result, utilize a publisher trend model in determining a long-term forecasting result, wherein the publisher trend model is associated with a publisher that is associated with the available future impression opportunity.
